(19) United States
(12) Patent Application Publication
(10) Pub. No.: US 2026/0196458 A1
(43) Pub. Date: Jul. 9, 2026

(54) SYSTEMS AND METHOD FOR PRODUCING A REACTION PRODUCT

(71) Applicant: Purdue Research Foundation, West Lafayette, IN (US)

(72) Inventors: Robert Graham Cooks, West Lafayette, IN (US); Kai-Hung Huang, West Lafayette, IN (US); Emily C. Dykhuizen, West Lafayette, IN (US); Nicholas Mauricio Morato Gutierrez, West Lafayette, IN (US)

(21) Appl. No.: 19/132,136

(22) PCT Filed: Nov. 29, 2023
(86) PCT No.: PCT/US2023/081535

§ 371 Date: May 22, 2025

Related U.S. Application Data
(60) Provisional application No. 63/428,531, filed on Nov. 29, 2022.

(51) Int. Cl. H01J 49/16

(52) U.S. Cl. CPC H01J 49/165

(57) ABSTRACT

The invention generally relates to systems and method for producing a reaction product. In certain aspects, the invention provides a reaction system that includes a first substrate, a desorption electrospray ionization (DESI) apparatus, a second substrate, and a control apparatus operably associated with each of the first and second substrates and the DESI apparatus such that the first and second substrates remain aligned with each other in a coordinated manner such that reagents at a first position on the first substrate are desorbed and ionized via the DESI apparatus to form a microdroplet in which the reagents in the microdroplet react with each other to form a reaction product that is landed at a first position on the second substrate that corresponds to the first position from the first substrate.

### RELATED APPLICATION

The present application claims the benefit of and priority to U.S. provisional patent application Ser. No. 63/428,531, filed Nov. 29, 2022, the content of which is incorporated by reference herein in its entirety.

### FIELD OF THE INVENTION

The invention generally relates to systems and method for producing a reaction product.

### BACKGROUND

The drug discovery process underpins the entire pharmaceutical industry, encompassing the early stages of research from target discovery and validation, right through to the identification of a drug candidate or lead compound. Initial identification of small therapeutic candidates comes about via a variety of streams. Research can lead to new insights into disease processes that highlight novel pathways for which drugs can be developed to intervene. Alternatively, companies conduct large scale trial and error-based programs in order to identify molecular compounds that may be of interest. This is the process most often performed during initial lead discovery, with a view to take novel compounds right the way through to preclinical and clinical trials. Thoroughly calculated risk analysis at this point can increase the chances of success when investments into a lead are made.

The drug discovery process from target identification and validation, hit identification and validation, moving from a hit to a lead, lead optimization, and late lead optimization, is a manually driven process that is fragmented and segmented into different manual processes and procedures. Accordingly, drug discovery is a time-consuming inefficient and unsynchronized process that ultimately results in the need for years to develop a commercial drug.

### SUMMARY

The invention provides a technology that is a key component of a multicomponent system that allows reactions to be screened for optimum production of products, e.g. chemicals that might be drug candidates, as well as collection of these products, as well as assaying their activity against biological targets, e.g. enzymes. A main feature of the technology are systems and methods of transferring reaction products of a set of reagents located at a particular point in an array of such chemical reagents, to a corresponding point on a receiving array, the reaction occurring in the course of the transfer. Particular approaches for implementation are described herein, and may, in certain embodiments, include any one or more (or combination of) the following: (i) the reaction can be carried out through the use of desorption electrospray ionization (DESI)/mass spectrometry (MS) to create microdroplets from each spot of the precursor array while chemical reactions occur in the microdroplets at accelerated rates to give products; (ii) the product containing droplets can be landed on a product (second) array in positions related by known parameters to the positions of the original reaction mixture on the precursor array; (iii) the nature of the product can be inferred by using DESI to ionize the deposited product and MS to identify this material; (iv) the biological activity of the product can be determined either by landing the product droplet on a surface prepared by addition of the biologically active substrate or by addition such biologically active substrate to particular or all positions of the as-prepared product array and then using DESI-MS again to measure biological activity.

The invention addresses the aforementioned problems in drug discovery. The invention provides an approach to determine how to rapidly generate a number of drug candidates, how to determine their chemical identities, how to estimate their purities, and how to determine their biological activities all without using any method of chromatographic separation or purification so as to maximize the speed and minimize the sample size whilst covering a wide range of chemical structures including sets of closely related chemicals. The provided systems and methods solve those problems by providing a single interconnected automated system, in which arrays of samples (reaction mixtures) are prepared by standard sample handling automated pipetting methods, then rapid reactions are caused by extraction of the reaction mixture into the solvent of a DESI spray while the extract is launched in the form of secondary microdroplets and transferred either to a mass spectrometer for chemical analysis or to a surface for subsequent analysis, or for reaction with a reagent including a biological substrate already placed on the receiving surface or subsequently added to that surface. The same or a second DESI sprayer is used to characterize the products of the biological reaction so determining the reactivity of the synthesized drug candidate.

In certain aspects, the invention provides a reaction system that includes a first substrate; a desorption electrospray ionization (DESI) apparatus; a second substrate; and a control apparatus operably associated with each of the first and second substrates and the DESI apparatus such that the first and second substrates remain aligned with each other in a coordinated manner such that reagents at a first position on the first substrate are desorbed and ionized via the DESI apparatus to form a microdroplet in which the reagents in the microdroplet react with each other to form a reaction product that is landed at a first position on the second substrate that corresponds to the first position from the first substrate.

In certain embodiments, the system further includes one or more mass spectrometers, each of which comprises an inlet, wherein: (i) the inlet of the mass spectrometer is positioned to be operably associated with the first substrate in order to perform an initial screening of the reagents at the first position of the first substrate in order to evaluate the reagents for determination of producing an appropriate reaction product of appropriate purity; and/or (ii) inlet is positioned to be operably associated with the second substrate such that the landed reaction product can be desorbed and ionized from the second substrate and desorbed molecules of the reaction product enter the inlet of the mass spectrometer and are analyzed. In certain embodiments, the DESI apparatus desorbs the landed reaction product. In other embodiments, the system further comprises a second desorption electrospray ionization (DESI) apparatus and the second DESI apparatus desorbs the landed reaction product.

The control apparatus may include one or more motors for controlling movement, alignment, and coordination of the first and second substrates and the DESI apparatus. In certain embodiments, the second substrate is oriented substantially perpendicular to the first substrate.

In certain embodiments, the first position on the second substrate comprises a biological molecule that reacts with the reaction product that is landed at a first position on the second substrate. In certain embodiments, the reaction product and biological molecule are desorbed and ionized from the second substrate and desorbed molecules of the reaction product and biological molecule enter the inlet of the mass spectrometer and biological activity is measured. In certain embodiments, system does not include a chromatographic separation apparatus. In certain embodiments, the system does not include a purification apparatus.

In other aspects, the invention provides methods of producing a reaction product that involve desorbing reagents from a first position on a first substrate via a desorption electrospray ionization (DESI) apparatus to form a microdroplet in which the reagents in the microdroplet react with each other to form a reaction product that is landed at a first position on a second substrate that corresponds to the first position from the first substrate due to the first and second substrates being aligned with each other in a coordinated manner.

In certain embodiments, the methods of the invention may additionally and/or optionally involve: (i) performing an initial screening of the reagents at the first position of the first substrate in order to evaluate the reagents for determination of producing an appropriate reaction product of appropriate purity; and/or (ii) desorbing and ionizing the landed reaction product from the second substrate such that desorbed molecules of the reaction product enter an inlet of a mass spectrometer and are analyzed in the mass spectrometer. In certain embodiments, the DESI apparatus desorbs the landed reaction product. In other embodiments, a second desorption electrospray ionization (DESI) apparatus desorbs the landed reaction product.

In certain embodiments, the first and second substrates and the DESI apparatus are controlled by a control apparatus that comprises one or more motors for controlling movement, alignment, and coordination of the first and second substrates and the DESI apparatus. In certain embodiments, the second substrate is oriented substantially perpendicular to the first substrate. In certain embodiments, the first position on the second substrate comprises a biological molecule that reacts with the reaction product that is landed at a first position on the second substrate. In certain embodiments, the reaction product and biological molecule are desorbed and ionized from the second substrate and desorbed molecules of the reaction product and biological molecule enter the inlet of the mass spectrometer and biological activity is measured. In certain embodiments, the method is conducted without any chromatographic separation. In certain embodiments, the method is conducted without any purification steps other than the DESI process.

### BRIEF DESCRIPTION OF THE DRAWINGS

FIGS. 1-2 provide an overview of the systems and methods of the invention.

FIG. 3 is an illustration showing an exemplary data analysis module for implementing the systems and methods of the invention in certain embodiments.

### DETAILED DESCRIPTION

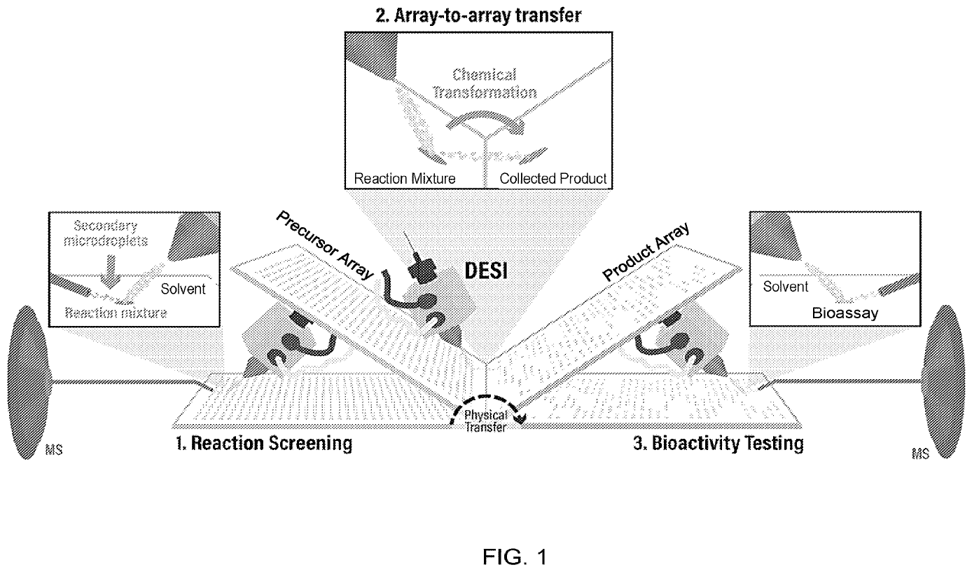

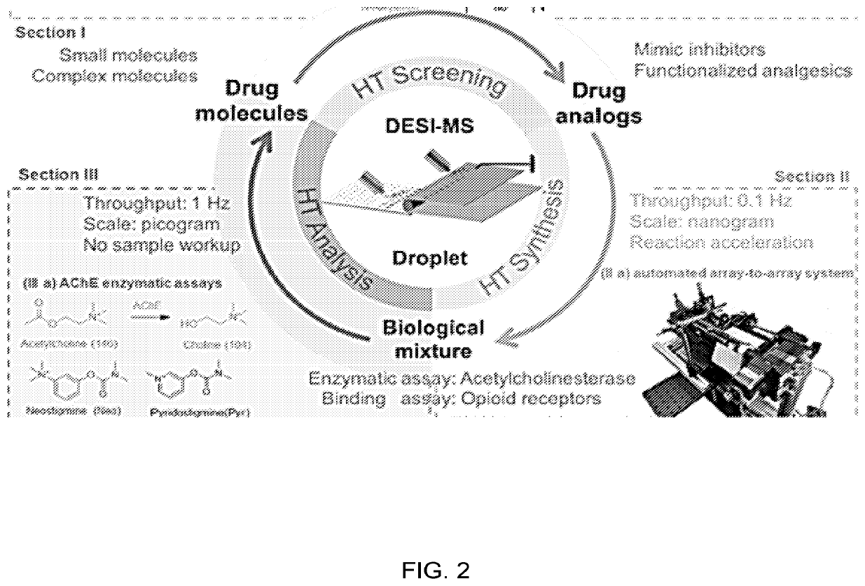

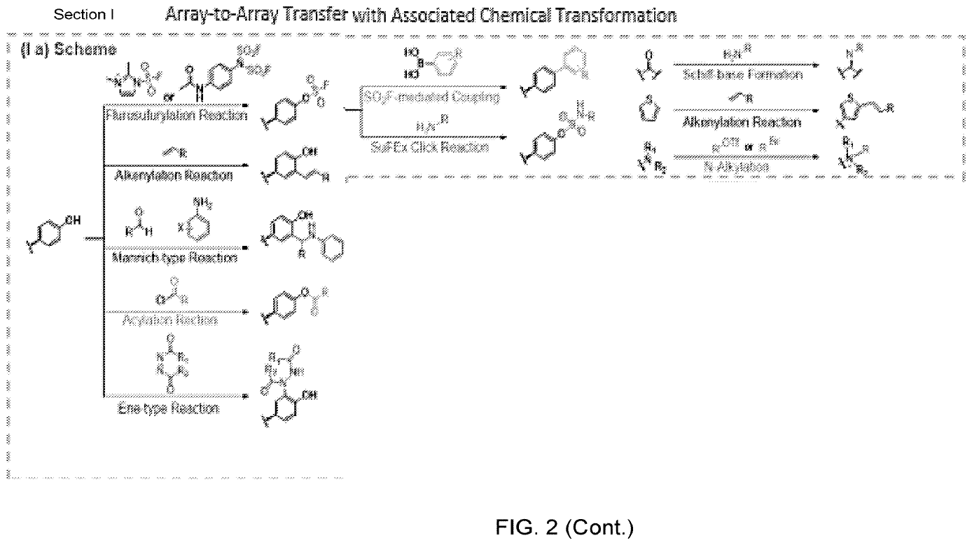

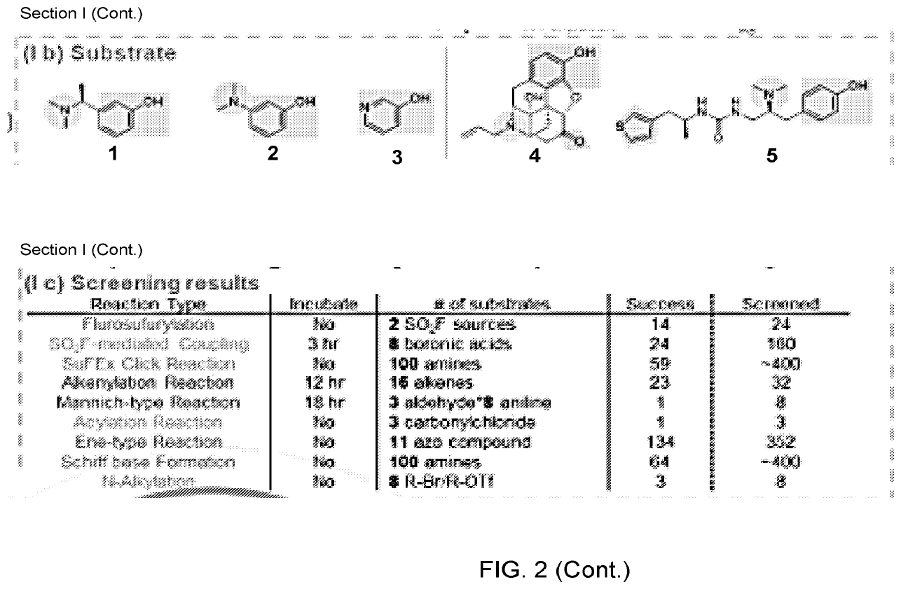

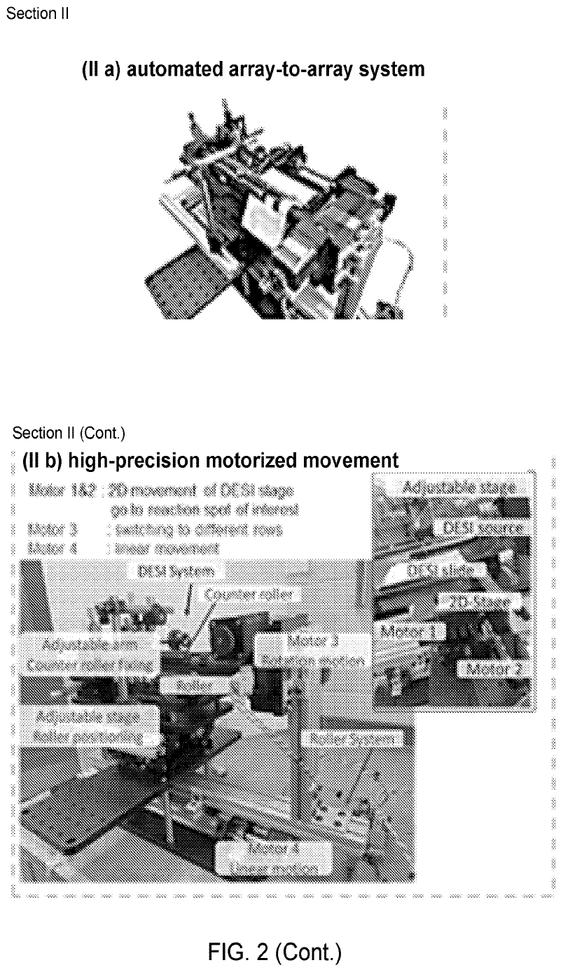

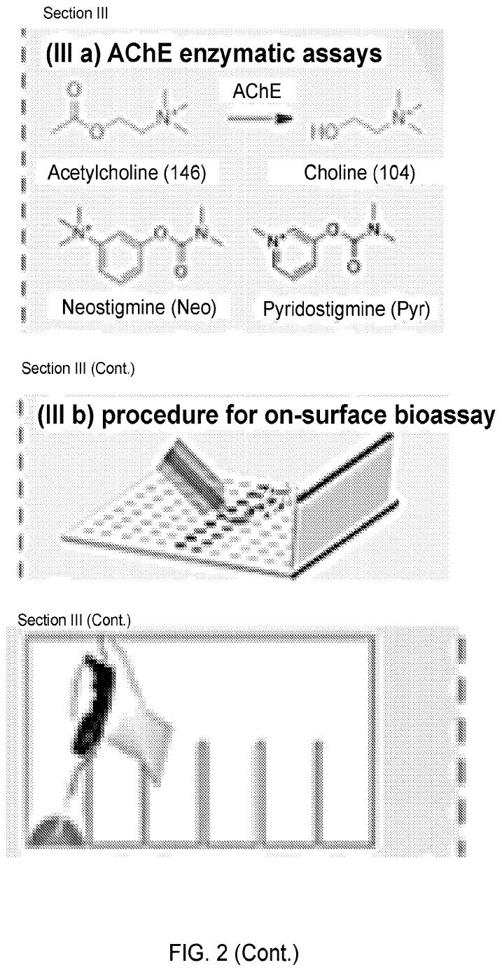

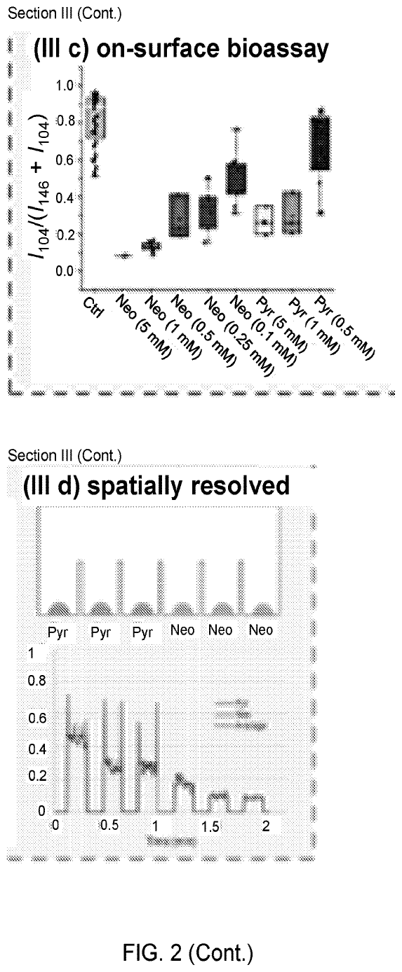

The invention generally relates to systems and method for producing a reaction product, and various embodiments are described in FIGS. 1-2. A system was developed utilizing a technology: high-throughput (HT) desorption electrospray ionization-mass spectrometry (DESI-MS) to accelerate the process of drug discovery. DESI is described for example in Takats et al (U.S. Pat. No. 7,335,897), the content of which is incorporated by reference herein in its entirety. DESI is a unique methodology serving not only as an analytical method but also as a synthetic tool. The contactless feature of DESI provides the capability for the direct analysis of complex and salty reaction/biological mixtures without any sample workup, and the phenomena of reaction acceleration in microdroplets provides access to extremely fast reactions. In certain embodiments, there are three components of the system as summarized in FIG. 1: (I) HT screening, (II) HT synthesis and (III) HT analysis. Two biological systems were studied (i) enzymatic assay of acetylcholinesterase (AChE) and (ii) binding assay of opioid receptors.

Using HT screening (FIG. 1 and FIG. 2, section I), we investigated the synthesis of AChE inhibitor mimics from small molecules (1, 2 and 3) as well as the late-stage functionalization for diversification of known analgesics (4 and 5) (FIG. 1 and FIG. 2, section I(b). Nine reaction types (fluorosufurylation, SO₂F mediated coupling, sulfur-fluoride exchange click reaction, alkenylation reaction, Mannich-type reaction, acylation reaction, ene-type reaction, Schiff base formation, and N-alkylation) were investigated by targeting moieties including the secondary amino group, phenol group, carbonyl group, and thiophene group (FIG. 1 and FIG. 2, section I(a) and I(c). HT-DESI-MS were utilized for the screening with a throughput of 1 Hz and a consumption of 50 nL of each sample pinned on a DESI slide. DESI as an analytical tool can directly determine the successful reactions without tedious purification even with complex reaction mixtures (alkenylation) or salty reaction mixtures (ene-type reaction). Moreover, DESI droplets can act as synthetic microreactors accelerating reactions and forming products without incubation. Over 200 different substrates and 2000 reaction conditions were screened. Over 50 different products were generated for the synthesis of inhibitor mimics (i), and many functionalized drug molecules were identified for the late-stage diversification of naloxone (>100) and PZM21 (15), respectively (ii). Moreover, the capability of reanalyzing the same sample on the DESI slide provides more detailed structural information (e.g. by MS/MS) on reaction products.

HT synthesis (FIG. 1 and FIG. 2, section II) was used to collect the products generated in the microdroplets as a complement to using MS for analysis. To achieve high-density and spatially resolved synthesis and analysis we built an array-to array system using a ‘typewriter’ like collection system (roller system labeled in red) and incorporated into a two-dimensional DESI stage (labeled in blue) (FIG. 1 and FIG. 2, section II(a)). The DESI system contains a DESI slide with various reaction mixtures in array format, a 2D stage for X and Y movement to examine the spots of interest and acquire information from the screening step, as well as stepping motors 1&2 for automation (FIG. 1 and FIG. 2, section II(b) blue). The roller system was composed of a roller and counter roller from an old fashion typewriter controlled by motor 3 for rotary motion, a rail controlled by motor 4 for linear motion, and several adjustable parts to maximize the stability of the system (FIG. 1 and FIG. 2, section II(b) red). The linear motion allows the collection of droplets in different positions of a single row, and rotary motion provides the ability for 2D collection of products in different rows. DESI serves as a ‘bridge’ connecting these two systems by desorbing the reaction mixtures from a high-density DESI array, allowing for accelerated reactions in the droplets and then their collection to generate another array (‘array-to-array’ synthesis). The system can be fully automated with high-precision and high-resolution movement (0.625 μm for all linear motion and 0.35 μm for rotary motion). The system was built but further evaluation is underway.

The third HT operation, analysis (FIG. 1 and FIG. 2, section III), involves a procedure for on-surface bioassays for the bioactivity evaluation of compounds synthesized in the previous two steps. We utilized AChE enzymatic assay and evaluated the inhibition of this enzyme using two different inhibitors, neostigmine and pyridostigmine (FIG. 1 and FIG. 2, section III(a)). The inhibitors were deposited on the surface by either directly pipetting inhibitors or collecting the inhibitors in DESI droplets to which the substrate (acetylcholine) as well as AChE were added sequentially. The activity of the enzyme and the inhibition efficiency were determined by measuring the ratio of ion abundances at m/z 146 and 104 (substrate and products of AChE), enabling a label-free determination of bioactivity (FIG. 1 and FIG. 2, section III(b)). The procedure was able to differentiate activity of various inhibitors at the same concentration (red and blue in (FIG. 1 and FIG. 2, section III(c)), or different concentrations of the same inhibitors (same color in (FIG. 1 and FIG. 2, section III9c)). Furthermore, the spatially resolved results ((FIG. 1 and FIG. 2, section III(d)) demonstrate the availability of evaluating various products that are deposited on the surface in a ‘make-to-measure’ fashion. The procedure is simple and automation compatible.

The invention herein illustrates that the iterative application of these three operations can be used to accelerate the process of drug discovery. DESI-MS is a versatile method that can be essential in both analysis and synthesis.

Certain aspects of fluid handling and mass spectrometry are described for example in PCT/US21/22923, the content of which is incorporated by reference herein in its entirety.

### Fluid Handling

Any fluid handling instrument known in the art can be used in systems of the invention. In certain embodiments, the liquid handling instrument is a Biomek liquid handler (for example I-series) as produced and sold by Beckman Coulter. Description of such liquid handler are described for example in U.S. Pat. Nos. 10,274,505; 10,048,284; 9,910,054; 9,519,000; 9,506,943; 9,482,684; 9,446,418; 9,285,382; 9,274,132; 9,140,715; 9,046,506; 9,046,455; 8,996,320; 8,973,736; 8,962,308; 8,956,570; 8,932,541; 8,840,848; 6,841,379; and 5,737,498, the content of each of which is incorporated by reference herein in its entirety.

### Desorption Electrospray Ionization

Desorption electrospray ionization (DESI) is described for example in Takats et al. (U.S. Pat. No. 7,335,897), the content of which is incorporated by reference herein in its entirety. DESI allows ionizing and desorbing a material (analyte) at atmospheric or reduced pressure under ambient conditions. A DESI system generally includes a device for generating a DESI-active spray by delivering droplets of a liquid into a nebulizing gas. The system also includes a means for directing the DESI-active spray onto a surface. It is understood that the DESI-active spray may, at the point of contact with the surface, include both or either charged and uncharged liquid droplets, gaseous ions, molecules of the nebulizing gas and of the atmosphere in the vicinity. The pneumatically assisted spray is directed onto the surface of a sample material where it interacts with one or more analytes, if present in the sample, and generates desorbed ions of the analyte or analytes. The desorbed ions can be directed to a mass analyzer for mass analysis, to an IMS device for separation by size and measurement of resulting voltage variations, to a flame spectrometer for spectral analysis, or the like.

In this system, a spray is generated by a conventional electrospray device. The device includes a spray capillary through which the liquid solvent is fed. A surrounding nebulizer capillary forms an annular space through which a nebulizing gas such as nitrogen (N₂) is fed at high velocity. In one example, the liquid was a water/methanol mixture and the gas was nitrogen. A high voltage is applied to the liquid solvent by a power supply via a metal connecting element. The result of the fast-flowing nebulizing gas interacting with the liquid leaving the capillary is to form the DESI-active spray comprising liquid droplets. DESI-active spray also may include neutral atmospheric molecules, nebulizing gas, and gaseous ions. Although an electrospray device has been described, any device capable of generating a stream of liquid droplets carried by a nebulizing gas jet may be used to form the DESI-active spray.

The spray is directed onto the sample material which in this example is supported on a surface. The desorbed ions leaving the sample are collected and introduced into the atmospheric inlet or interface of a mass spectrometer for analysis by an ion transfer line which is positioned in sufficiently close proximity to the sample to collect the desorbed ions. Surface may be a moveable platform or may be mounted on a moveable platform that can be moved in the x, y or z directions by well-known drive means to desorb and ionize sample at different areas, sometimes to create a map or image of the distribution of constituents of a sample. Electric potential and temperature of the platform may also be controlled by known means. Any atmospheric interface that is normally found in mass spectrometers will be suitable for use in the invention. Good results have been obtained using a typical heated capillary atmospheric interface. Good results also have been obtained using an atmospheric interface that samples via an extended flexible ion transfer line made either of metal or an insulator.

### Ion Traps and Mass Spectrometers

Any ion trap known in the art can be used in systems of the invention. Exemplary ion traps include a hyperbolic ion trap (e.g., U.S. Pat. No. 5,644,131, the content of which is incorporated by reference herein in its entirety), a cylindrical ion trap (e.g., Bonner et al., International Journal of Mass Spectrometry and Ion Physics, 24(3):255-269, 1977, the content of which is incorporated by reference herein in its entirety), a linear ion trap (Hagar, Rapid Communications in Mass Spectrometry, 16(6):512-526, 2002, the content of which is incorporated by reference herein in its entirety), and a rectilinear ion trap (U.S. U.S. Pat. No. 6,838,666, the content of which is incorporated by reference herein in its entirety).

Any mass spectrometer (e.g., bench-top mass spectrometer of miniature mass spectrometer) may be used in systems of the invention and in certain embodiments the mass spectrometer is a miniature mass spectrometer. An exemplary miniature mass spectrometer is described, for example in Gao et al. (Anal. Chem. 2008, 80, 7198-7205.), the content of which is incorporated by reference herein in its entirety. In comparison with the pumping system used for lab-scale instruments with thousands of watts of power, miniature mass spectrometers generally have smaller pumping systems, such as a 18 W pumping system with only a 5 L/min (0.3 m3/hr) diaphragm pump and a 11 L/s turbo pump for the system described in Gao et al. Other exemplary miniature mass spectrometers are described for example in Gao et al. (Anal. Chem., 2008, 80, 7198-7205.), Hou et al. (Anal. Chem., 2011, 83, 1857-1861.), and Sokol et al. (Int. J. Mass Spectrom., 2011, 306, 187-195), the content of each of which is incorporated herein by reference in its entirety.

The control system of the Mini 12 (Linfan Li, Tsung-Chi Chen, Yue Ren, Paul I. Hendricks, R. Graham Cooks and Zheng Ouyang “Miniature Ambient Mass Analysis System” Anal. Chem. 2014, 86 2909-2916, DOI: 10.1021/ac403766c; and 860. Paul I. Hendricks, Jon K. Dalgleish, Jacob T. Shelley, Matthew A. Kirleis, Matthew T. McNicholas, Linfan Li, Tsung-Chi Chen, Chien-Hsun Chen, Jason S. Duncan, Frank Boudreau, Robert J. Noll, John P. Denton, Timothy A. Roach, Zheng Ouyang, and R. Graham Cooks “Autonomous in-situ analysis and real-time chemical detection using a backpack miniature mass spectrometer: concept, instrumentation development, and performance” Anal. Chem., 2014, 86 2900-2908 DOI: 10.1021/ac403765x, the content of each of which is incorporated by reference herein in its entirety), and the vacuum system of the Mini 10 (Liang Gao, Qingyu Song, Garth E. Patterson, R. Graham Cooks and Zheng Ouyang, “Handheld Rectilinear Ion Trap Mass Spectrometer”, Anal. Chem., 78(2006 ) 5994-6002 DOI: 10.1021/ac061144k, the content of which is incorporated by reference herein in its entirety) may be combined to produce the miniature mass spectrometer shown in FIG. 9. It may have a size similar to that of a shoebox (H 20 cm×W25 cm×D35 cm). In certain embodiments, the miniature mass spectrometer uses a dual LIT configuration, which is described for example in Owen et al. (U.S. patent application Ser. No. 14/345,672), and Ouyang et al. (U.S. patent application Ser. No. 61/865,377), the content of each of which is incorporated by reference herein in its entirety.

### System Architecture

In certain embodiments, the systems and methods of the invention can be carried out using automated systems and computing devices. Specifically, aspects of the invention described herein can be performed using any type of computing device, such as a computer, that includes a processor, e.g., a central processing unit, or any combination of computing devices where each device performs at least part of the process or method. In some embodiments, systems and methods described herein may be controlled using a handheld device, e.g., a smart tablet, or a smart phone, or a specialty device produced for the system.

Systems and methods of the invention can be performed using software, hardware, firmware, hardwiring, or combinations of any of these. Features implementing functions can also be physically located at various positions, including being distributed such that portions of functions are implemented at different physical locations (e.g., imaging apparatus in one room and host workstation in another, or in separate buildings, for example, with wireless or wired connections).

Processors suitable for the execution of computer program include, by way of example, both general and special purpose microprocessors, and any one or more processor of any kind of digital computer. Generally, a processor will receive instructions and data from a read-only memory or a random access memory or both. The essential elements of computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, solid state drive (SSD), and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having an I/O device, e.g., a CRT, LCD, LED, or projection device for displaying information to the user and an input or output device such as a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected through network by any form or medium of digital data communication, e.g., a communication network. For example, the reference set of data may be stored at a remote location and the computer communicates across a network to access the reference set to compare data derived from the female subject to the reference set. In other embodiments, however, the reference set is stored locally within the computer and the computer accesses the reference set within the CPU to compare subject data to the reference set. Examples of communication networks include cell network (e.g., 3G or 4G), a local area network (LAN), and a wide area network (WAN), e.g., the Internet.

The subject matter described herein can be implemented as one or more computer program products, such as one or more computer programs tangibly embodied in an information carrier (e.g., in a non-transitory computer-readable medium) for execution by, or to control the operation of, data processing apparatus (e.g., a programmable processor, a computer, or multiple computers). A computer program (also known as a program, software, software application, app, macro, or code) can be written in any form of programming language, including compiled or interpreted languages (e.g., C, C++, Perl), and it can be deployed in any form, including as a stand-alone program or as a module, component, subroutine, or other unit suitable for use in a computing environment. Systems and methods of the invention can include instructions written in any suitable programming language known in the art, including, without limitation, C, C++, Perl, Java, ActiveX, HTML5, Visual Basic, or JavaScript.

A computer program does not necessarily correspond to a file. A program can be stored in a file or a portion of file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

A file can be a digital file, for example, stored on a hard drive, SSD, CD, or other tangible, non-transitory medium. A file can be sent from one device to another over a network (e.g., as packets being sent from a server to a client, for example, through a Network Interface Card, modem, wireless card, or similar).

Writing a file according to the invention involves transforming a tangible, non-transitory computer-readable medium, for example, by adding, removing, or rearranging particles (e.g., with a net charge or dipole moment into patterns of magnetization by read/write heads), the patterns then representing new collocations of information about objective physical phenomena desired by, and useful to, the user. In some embodiments, writing involves a physical transformation of material in tangible, non-transitory computer readable media (e.g., with certain optical properties so that optical read/write devices can then read the new and useful collocation of information, e.g., burning a CD-ROM). In some embodiments, writing a file includes transforming a physical flash memory apparatus such as NAND flash memory device and storing information by transforming physical elements in an array of memory cells made from floating-gate transistors. Methods of writing a file are well-known in the art and, for example, can be invoked manually or automatically by a program or by a save command from software or a write command from a programming language.

Suitable computing devices typically include mass memory, at least one graphical user interface, at least one display device, and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory, or other memory technology, CD-ROM, digital versatile disks (DVD) or other optical storage, magnetic cassettes, magnetic tape, magnetic disk storage or other magnetic storage devices, Radiofrequency Identification tags or chips, or any other medium which can be used to store the desired information and which can be accessed by a computing device.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

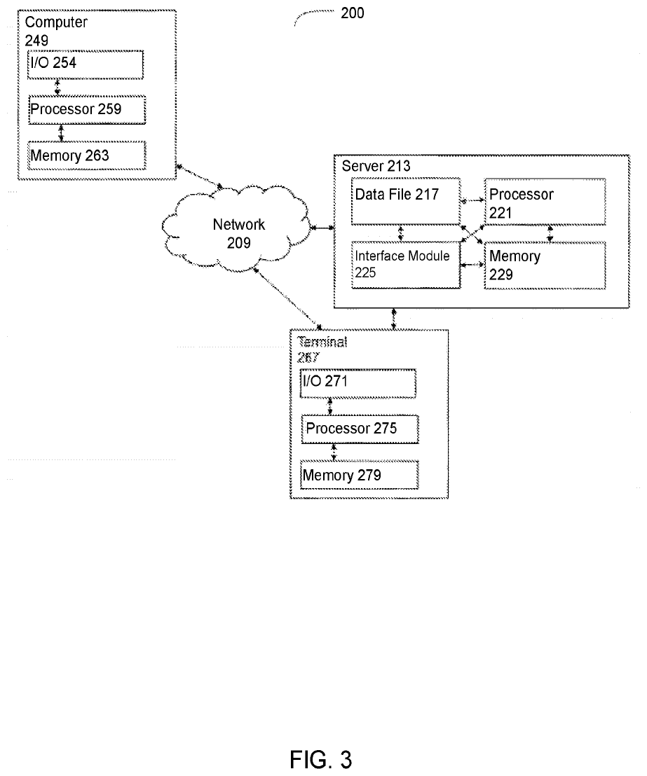

In an exemplary embodiment shown in FIG. 3, system 200 can include a computer 249 (e.g., laptop, desktop, or tablet). The computer 249 may be configured to communicate across a network 209. Computer 249 includes one or more processor 259 and memory 263 as well as an input/output mechanism 254. Where methods of the invention employ a client/server architecture, steps of methods of the invention may be performed using server 213, which includes one or more of processor 221 and memory 229, capable of obtaining data, instructions, etc., or providing results via interface module 225 or providing results as a file 217. Server 213 may be engaged over network 209 through computer 249 or terminal 267, or server 213 may be directly connected to terminal 267, including one or more processor 275 and memory 279, as well as input/output mechanism 271.

System 200 or machines according to the invention may further include, for any of I/O 249, 237, or 271 a video display unit (e.g., a liquid crystal display (LCD) or a cathode ray tube (CRT)). Computer systems or machines according to the invention can also include an alphanumeric input device (e.g., a keyboard), a cursor control device (e.g., a mouse), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

Memory 263, 279, or 229 according to the invention can include a machine-readable medium on which is stored one or more sets of instructions (e.g., software) embodying any one or more of the methodologies or functions described herein. The software may also reside, completely or at least partially, within the main memory and/or within the processor during execution thereof by the computer system, the main memory and the processor also constituting machine-readable media. The software may further be transmitted or received over a network via the network interface device.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein.

What is claimed is:

1. A reaction system comprising:
a first substrate;
a desorption electrospray ionization (DESI) apparatus;
a second substrate; and
a control apparatus operably associated with each of the first and second substrates and the DESI apparatus such that the first and second substrates remain aligned with each other in a coordinated manner such that reagents at a first position on the first substrate are desorbed and ionized via the DESI apparatus to form a microdroplet in which the reagents in the microdroplet react with each other to form a reaction product that is landed at a first position on the second substrate that corresponds to the first position from the first substrate.

2. The system of claim 1, further comprising one or more mass spectrometers, each of which comprises an inlet, wherein:
(i) the inlet of the mass spectrometer is positioned to be operably associated with the first substrate in order to perform an initial screening of the reagents at the first position of the first substrate in order to evaluate the reagents for determination of producing an appropriate reaction product of appropriate purity; and/or
(ii) inlet is positioned to be operably associated with the second substrate such that the landed reaction product can be desorbed and ionized from the second substrate and desorbed molecules of the reaction product enter the inlet of the mass spectrometer and are analyzed.

3. The system of claim 2, wherein the DESI apparatus desorbs the landed reaction product.

4. The system of claim 2, wherein the system further comprises a second desorption electrospray ionization (DESI) apparatus and the second DESI apparatus desorbs the landed reaction product.

5. The system of claim 1, wherein the control apparatus comprises one or more motors for controlling movement, alignment, and coordination of the first and second substrates and the DESI apparatus.

6. The system of claim 1, wherein the second substrate is oriented substantially perpendicular to the first substrate.

7. The system of claim 1, wherein the first position on the second substrate comprises a biological molecule that reacts with the reaction product that is landed at a first position on the second substrate.

8. The system of claim 7, wherein the reaction product and biological molecule are desorbed and ionized from the second substrate and desorbed molecules of the reaction product and biological molecule enter the inlet of the mass spectrometer and biological activity is measured.

9. The system of claim 1, wherein the system does not include a chromatographic separation apparatus.

10. The system of claim 1, wherein the system does not include a purification apparatus.

11. A method of producing a reaction product, the method comprising: desorbing reagents from a first position on a first substrate via a desorption electrospray ionization (DESI) apparatus to form a microdroplet in which the reagents in the microdroplet react with each other to form a reaction product that is landed at a first position on a second substrate that corresponds to the first position from the first substrate due to the first and second substrates being aligned with each other in a coordinated manner.

12. The method of claim 11, further comprising:
(i) performing an initial screening of the reagents at the first position of the first substrate in order to evaluate the reagents for determination of producing an appropriate reaction product of appropriate purity; and/or
(ii) desorbing and ionizing the landed reaction product from the second substrate such that desorbed molecules of the reaction product enter an inlet of a mass spectrometer and are analyzed in the mass spectrometer.

13. The method of claim 12, wherein the DESI apparatus desorbs the landed reaction product.

14. The method of claim 12, wherein a second desorption electrospray ionization (DESI) apparatus desorbs the landed reaction product.

15. The method of claim 11, wherein the first and second substrates and the DESI apparatus are controlled by a control apparatus that comprises one or more motors for controlling movement, alignment, and coordination of the first and second substrates and the DESI apparatus.

16. The method of claim 11, wherein the second substrate is oriented substantially perpendicular to the first substrate.

17. The method of claim 11, wherein the first position on the second substrate comprises a biological molecule that reacts with the reaction product that is landed at a first position on the second substrate.

18. The method of claim 17, wherein the reaction product and biological molecule are desorbed and ionized from the second substrate and desorbed molecules of the reaction product and biological molecule enter the inlet of the mass spectrometer and biological activity is measured.

19. The method of claim 11, wherein the method is conducted without any chromatographic separation.

20. The method of claim 11, wherein the method is conducted without any purification steps other than the DESI process.
